(19) United States
(12) Patent Application Publication
(10) Pub. No.: US 2018/0103788 A1
(43) Pub. Date: Apr. 19, 2018

(54) Light Emitting Ornament Assembly

(71) Applicant: Yvonne Kitchen, Chesapeake, VA (US)

(72) Inventor: Yvonne Kitchen, Chesapeake, VA (US)

(21) Appl. No.: 15/295,541

(22) Filed: Oct. 17, 2016

(51) Int. Cl. A47G 33/08; F21V 21/08; F21V 23/00; F21V 23/06; F21V 3/00; F21L 4/08

(52) U.S. Cl. CPC A47G 33/08; F21V 21/0816; F21V 23/001; F21W 2121/00; F21V 3/00; F21L 4/08; A47G 2033/0827; F21V 23/06

(57) ABSTRACT

A light emitting ornament assembly is provided for publicly displaying breast cancer awareness. The assembly includes an ornament structured to resemble a breast cancer ribbon. The ornament may be positioned outdoors thereby facilitating the ornament to be observed. A plurality of light emitters is provided. Each of the light emitters is coupled to the panel. Thus, each of the light emitters emits light outwardly from the panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including Information Disclosed under 37 CFR 1.97 and 1.98

The disclosure and prior art relates to ornament devices and more particularly pertains to a new ornament device for publicly displaying breast cancer awareness.

### BRIEF SUMMARY OF THE INVENTION

An embodiment of the disclosure meets the needs presented above by generally comprising an ornament. The ornament is structured to resemble a breast cancer ribbon. The ornament may be positioned outdoors thereby facilitating the ornament may be observed. A plurality of light emitters is provided. Each of the light emitters is coupled to the panel. Thus, each of the light emitters emits light outwardly from the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a light emitting ornament assembly according to an embodiment of the disclosure.

FIG. 2 is a back view of an embodiment of the disclosure.

FIG. 3 is a right side view of an embodiment of the disclosure.

FIG. 4 is a perspective in-use view of an embodiment of the disclosure.

FIG. 5 is a perspective in-use view of an embodiment of the disclosure.

### DETAILED DESCRIPTION OF THE INVENTION

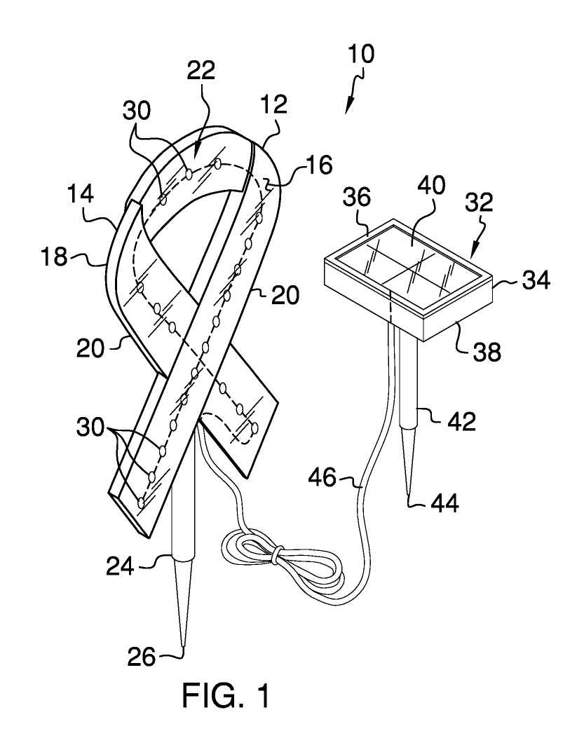

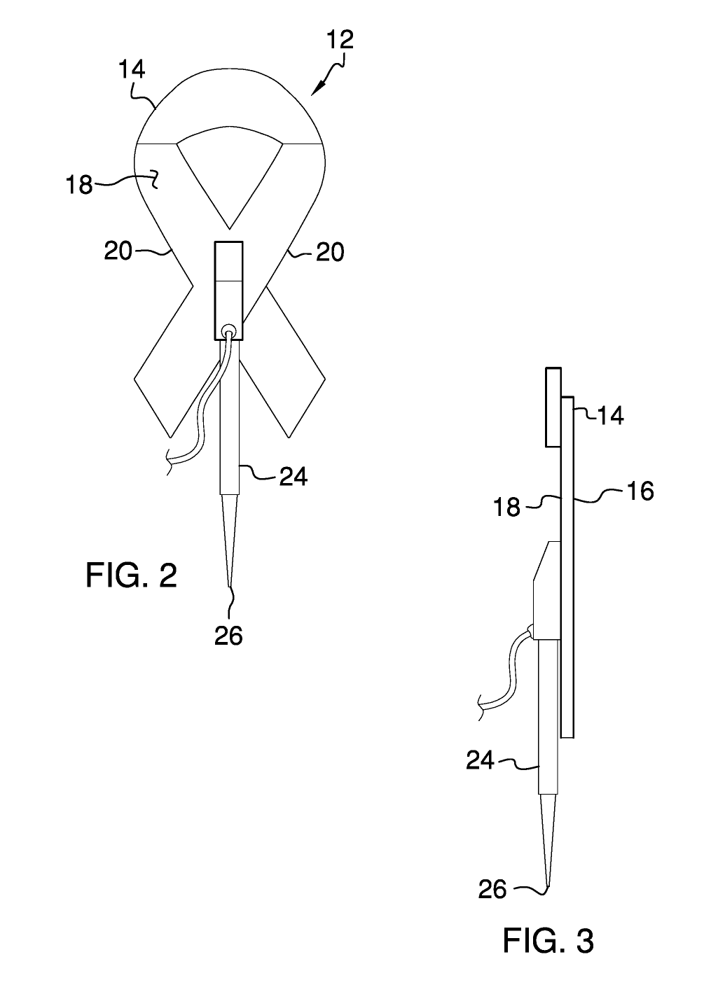

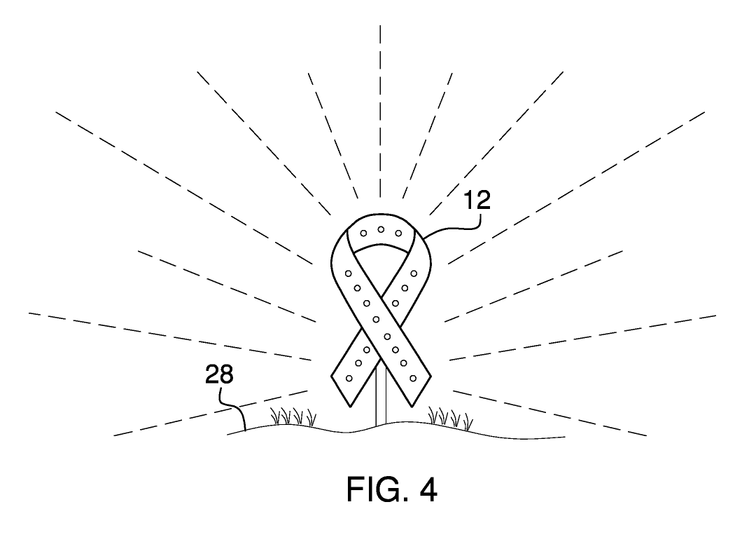

With reference now to the drawings, and in particular to FIGS. 1 through 5 thereof, a new ornament device embodying the principles and concepts of an embodiment of the disclosure and generally designated by the reference numeral 10 will be described.

As best illustrated in FIGS. 1 through 5, the light emitting ornament assembly 10 generally comprises an ornament 12. The ornament 12 may be positioned outdoors. Thus, the ornament 12 may be observed. Moreover, the ornament 12 may be placed in a yard of a house or the like.

The ornament 12 comprises a panel 14 that has a first surface 16 and a second surface 18. Moreover, the panel 14 comprises a pair of interlaced arms 20. Thus, the panel 14 has an ornamental appearance of a breast cancer ribbon. The first surface 16 may have a recessed portion 22. The recessed portion 22 may extend between each of the interlaced arms 20 thereby enhancing a three dimensional appearance of the breast cancer ribbon.

A first stake 24 is coupled to second surface 18. The first stake 24 has a distal end 26 with respect to the panel 14 and the first stake 24 is vertically oriented on the panel 14. The first stake 24 tapers to a point at the distal end 26. Thus, the distal end 26 may penetrate a support surface 28 thereby facilitating the panel 14 to be spaced from the support surface 28. The support surface 28 may be ground.

A plurality of light emitters 30 is provided. Each of the light emitters 30 is coupled to the panel 14. Thus, each of the light emitters 30 emits light outwardly from the panel 14. Each of the light emitters 30 is positioned on the first surface 16 of the panel 14. The light emitters 30 are spaced apart from each other and are distributed along the panel 14. Each of the light emitters 30 may comprise an LED or the like.

A power supply 32 is electrically coupled to the plurality of light emitters 30. The power supply 32 comprises a plate 34 that has a top side 36 and a bottom side 38. A solar panel 40 is coupled to the top side 36 of the panel 14. Thus, the solar panel 40 is exposed to sunlight.

A second stake 42 is coupled to the bottom side 38 and the second stake 42 has a distal end 44 with respect to the plate 34. The second stake 42 tapers to a point at the distal end 44 of the second stake 42. Thus, the distal end 44 of the second stake 42 may penetrate the support surface 28 thereby facilitating the plate 34 to be spaced from the support surface 28. A conductor 46 is electrically coupled between the solar panel 40 and the plurality of light emitters 30. The conductor 46 may be an insulated wire or the like.

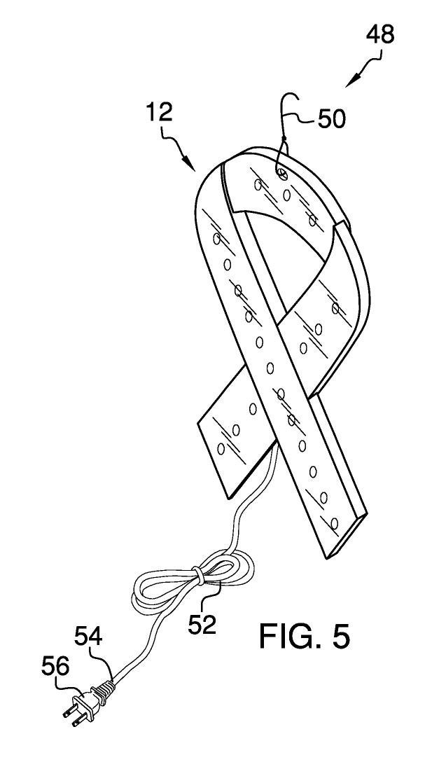

In an alternative embodiment 48 as shown in FIG. 5, a hook 50 may be coupled to the panel 14. Thus, the panel 14 may be suspended from a support. A power cord 52 may be coupled to the panel 14 and the power cord 52 may be electrically coupled to the plurality of light emitters 30. The power cord 52 may have a distal end 54 with respect to the panel 14. A plug 56 may be electrically coupled to the distal end 54 and the plug 56 may be electrically coupled to an electrical outlet.

In use, the ornament 12 is positioned outdoors and the distal end of the first stake 24 is inserted into the support surface 28. The distal end of the second stake 42 is inserted into the support surface 28. The solar panel 40 converts solar energy into electrical energy to power the light emitters 30. The light emitters 30 emit light thereby enhancing visibility of the panel 14. The ornament 12 facilitates a public display of breast cancer awareness.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A light emitting ornament assembly being configured to be display support for breast cancer awareness, said assembly comprising:
an ornament being configured to be positioned outdoors thereby facilitating said ornament to be observed, the ornament is structured to resemble a breast caner awareness ribbon; and
a plurality of light emitters, each of said light emitters being coupled to said panel wherein each of said light emitters is configured to emit light outwardly from said panel.

2. The assembly according to claim 1, wherein said ornament comprises a panel having a first surface and a second surface, said panel comprising a pair of interlaced arms wherein said panel is configured to have an ornamental appearance of a breast cancer ribbon.

3. The assembly according to claim 2, further comprising a first stake being coupled to second surface, said first stake having a distal end with respect to said panel, said first stake being vertically oriented on said panel, said first stake tapering to a point at said distal end wherein said distal end is configured to penetrate a support surface thereby facilitating said panel to be spaced from the support surface.

4. The assembly according to claim 2, wherein each of said light emitters is positioned on said first surface of said panel, said light emitters being spaced apart from each other and being distributed along said panel.

5. The assembly according to claim 1, further comprising a power supply being electrically coupled to said plurality of light emitters.

6. The assembly according to claim 5, wherein said power supply comprises:
a panel having a top side and a bottom side; and
a solar panel being coupled to said top side of said panel wherein said solar panel is configured to be exposed to sunlight.

7. The assembly according to claim 5, further comprising a second stake being coupled to said bottom side, said second stake having a distal end with respect to said plate, said second stake tapering to a point at said distal end wherein said distal end of said second stake is configured to penetrate a support surface thereby facilitating said plate to be spaced from the support surface.

8. The assembly according to claim 6, further comprising a conductor being electrically coupled between said solar panel and said plurality of light emitters.

9. A light emitting ornament assembly being configured to be display support for breast cancer awareness, said assembly comprising:
an ornament being configured to be positioned outdoors thereby facilitating said ornament to be observed, said ornament comprising:
a panel having a first surface and a second surface, said panel comprising a pair of interlaced arms wherein said panel is configured to have an ornamental appearance of a breast cancer ribbon, and
a first stake being coupled to second surface, said first stake having a distal end with respect to said panel, said first stake being vertically oriented on said panel, said first stake tapering to a point at said distal end wherein said distal end is configured to penetrate a support surface thereby facilitating said panel to be spaced from the support surface;
a plurality of light emitters, each of said light emitters being coupled to said panel wherein each of said light emitters is configured to emit light outwardly from said panel, each of said light emitters being positioned on said first surface of said panel, said light emitters being spaced apart from each other and being distributed along said panel; and
a power supply being electrically coupled to said plurality of light emitters, said power supply comprising:
a plate having a top side and a bottom side,
a solar panel being coupled to said top side of said panel wherein said solar panel is configured to be exposed to sunlight,
a second stake being coupled to said bottom side, said second stake having a distal end with respect to said plate, said second stake tapering to a point at said distal end wherein said distal end of said second stake is configured to penetrate the support surface thereby facilitating said plate to be spaced from the support surface, and
a conductor being electrically coupled between said solar panel and said plurality of light emitters.
